(19) United States
(12) Patent Application Publication
(10) Pub. No.: US 2026/0031041 A1
(43) Pub. Date: Jan. 29, 2026

(54) PIXEL OF A DISPLAY DEVICE AND DISPLAY DEVICE

(71) Applicant: Samsung Display Co., Ltd., Yongin-Si (KR)

(72) Inventors: YOUNGWAN SEO, Yongin-si (KR); HYUNJOON KIM, Yongin-si (KR); JUNGHWAN HWANG, Yongin-si (KR)

(21) Appl. No.: 19/274,688

(22) Filed: Jul. 21, 2025

(30) Foreign Application Priority Data
Jul. 26, 2024 (KR) 10-2024-0099245
Mar. 6, 2025 (KR) 10-2025-0028927

(51) Int. Cl. G09G 3/3233

(52) U.S. Cl. CPC G09G 3/3233; G09G 2300/0465; G09G 2300/0819; G09G 2300/0842; G09G 2300/0861; G09G 2310/08; G09G 2320/0233

(57) ABSTRACT

A pixel of a display device includes a first transistor including a gate connected to a first node, a first terminal receiving a first power supply voltage and a second terminal connected to a second node, a capacitor disposed between a third node and the second node, a second transistor including a gate receiving a write signal, a first terminal connected to a data line and a second terminal connected to the third node, a third transistor including a gate receiving the write signal, a first terminal receiving a reference voltage and a second terminal connected to the first node, a fourth transistor including a gate receiving an emission signal, a first terminal connected to the first node and a second terminal connected to the third node, and a light-emitting element including an anode connected to the second node and a cathode receiving a second power supply voltage.

### CROSS-REFERENCE TO RELATED APPLICATION(S)

This application claims priority to and the benefits of Korean Patent Application No. 10-2024-0099245, filed on Jul. 26, 2024 in the Korean Intellectual Property Office, and Korean Patent Application No. 10-2025-0028927, filed on Mar. 6, 2025 in the Korean Intellectual Property Office, the entire contents of which are incorporated herein by reference.

### BACKGROUND

### 1. Field

Embodiments of the present disclosure relate to a pixel and a display device including the pixel.

### 2. Description of the Related Art

A pixel of a display device may include a storage capacitor, a scan transistor that transfers a data voltage to the storage capacitor in response to a write signal, a driving transistor that generates a driving current based on the data voltage stored in the storage capacitor, and a light-emitting element that emits light based on the driving current.

If a threshold voltage of the driving transistor in each pixel changes, the pixel may not emit light at a desired brightness. To eliminate or reduce a luminance error due to such a change in the threshold voltage, the pixel may further include transistors for performing a threshold voltage compensation operation. However, in order to increase a resolution of the display device, it may be preferable to reduce the number of transistors and capacitors included in the pixel.

### SUMMARY

Embodiments of the present disclosure provide a pixel of a display device having a simple configuration and being capable of performing a threshold voltage compensation operation.

Embodiments of the present disclosure provide a display device including the pixel.

Embodiments of the present disclosure provide an electronic device including the display device.

According to an embodiment of the present disclosure, a pixel of a display device includes a first transistor including a gate connected to a first node, a first terminal receiving a first power supply voltage and a second terminal connected to a second node, a capacitor including a first electrode connected to a third node and a second electrode connected to the second node, a second transistor including a gate receiving a write signal, a first terminal connected to a data line and a second terminal connected to the third node, a third transistor including a gate receiving the write signal, a first terminal receiving a reference voltage and a second terminal connected to the first node, a fourth transistor including a gate receiving an emission signal, a first terminal connected to the first node and a second terminal connected to the third node, and a light-emitting element including an anode connected to the second node and a cathode receiving a second power supply voltage.

The display device may include a plurality of pixels. The emission signal may be substantially simultaneously applied to the plurality of pixels. The write signal may be substantially simultaneously applied to the plurality of pixels in an initialization period, and may be sequentially applied to the plurality of pixels on a row-by-row basis in a compensation period.

The first power supply voltage may have a first low voltage level in an initialization period, and may have a first high voltage level in a compensation period, a data writing period and an emission period. The second power supply voltage may have a second high voltage level in the initialization period, the compensation period and the data writing period, and may have a second low voltage level in the emission period.

The reference voltage may be provided through the data line in the initialization period.

A frame period for the display device may include an initialization period in which the first node and the anode of the light-emitting element are initialized, a compensation period in which a threshold voltage of the first transistor is compensated, a data writing period in which a data voltage is provided through the data line, and an emission period in which the light-emitting element emits light.

In the initialization period, the first power supply voltage may have a first low voltage level, the second power supply voltage may have a second high voltage level, the write signal may have an on-level, the emission signal may have an off-level, and the reference voltage may be provided through the data line. The third transistor may be turned on in response to the write signal having the on-level and may transfer the reference voltage to the first node, and the second transistor may be turned on in response to the write signal having the on-level and may transfer the reference voltage from the data line to the third node. The first transistor may be turned on in response to the reference voltage at the first node and may transfer the first power supply voltage having the first low voltage level to the anode of the light-emitting element, and the first node may be initialized based on the reference voltage. The anode of the light-emitting element may be initialized based on the first power supply voltage having the first low voltage level.

In the compensation period, the first power supply voltage may have a first high voltage level, the second power supply voltage may have a second high voltage level, and the emission signal may have an off-level. The first transistor may be turned on until a voltage of the second node becomes a voltage obtained by subtracting the threshold voltage of the first transistor from the reference voltage.

In the data writing period, the first power supply voltage may have a first high voltage level, the second power supply voltage may have a second high voltage level, the write signal may have an on-level, the emission signal may have an off-level, and the data voltage may be provided through the data line. The third transistor may be turned on in response to the write signal having the on-level and may transfer the reference voltage to the first node, and the second transistor may be turned on in response to the write signal having the on-level and may transfer the data voltage from the data line to the third node. The first transistor may be turned on in response to the reference voltage at the first node, and the capacitor may store, between the first electrode and the second electrode, a voltage obtained by subtracting the reference voltage from the data voltage and adding the threshold voltage of the first transistor. The data writing period may be within the compensation period.

In the emission period, the first power supply voltage may have a first high voltage level, the second power supply voltage may have a second low voltage level, the write signal may have an off-level, and the emission signal may have an on-level. The fourth transistor may be turned on in response to the emission signal having the on-level and may connect the third node to the first node, and the first transistor may generate a driving current based on a voltage stored in the capacitor. The light-emitting element may emit light based on the driving current.

The display device may include a plurality of pixels. The emission signal may be substantially simultaneously applied to the plurality of pixels. The write signal may be substantially simultaneously applied to the plurality of pixels in the initialization period, and may be sequentially applied to the plurality of pixels on a row-by-row basis in the compensation period.

The display device may include a plurality of pixels. The emission signal may be sequentially applied to the plurality of pixels on a row-by-row basis, and the write signal may be sequentially applied to the plurality of pixels on a row-by-row basis.

The first transistor may be an N-type metal-oxide-semiconductor transistor.

The pixel may further include a fifth transistor located between the second node and the anode of the light-emitting element, and configured to connect the anode of the light-emitting element to the second node in response to another emission signal.

The display device may have a resolution of about 1,000 pixels per inch (PPI) or more.

According to an embodiment of the present disclosure, a display device includes a display panel including a plurality of pixels, a data driver configured to provide a data voltage to each of the plurality of pixels, a scan driver configured to provide a write signal to each of the plurality of pixels, and a controller configured to control the data driver and the scan driver. Each of the plurality of pixels includes a first transistor including a gate connected to a first node, a first terminal receiving a first power supply voltage and a second terminal connected to a second node, a capacitor including a first electrode connected to a third node and a second electrode connected to the second node, a second transistor disposed between a data line and the third node and transferring the data voltage to the third node in response to the write signal, a third transistor connected to the first node and transferring a reference voltage to the first node in response to the write signal, a fourth transistor disposed between the third node and the first node and connecting the third node to the first node in response to an emission signal, and a light-emitting element including an anode connected to the second node and a cathode receiving a second power supply voltage.

The scan driver may substantially simultaneously apply the write signal to the plurality of pixels in an initialization period, and may sequentially apply the write signal to the plurality of pixels on a row-by-row basis in a compensation period. The controller may simultaneously apply the emission signal to the plurality of pixels.

The display device may have a resolution of about 1,000 pixels per inch (PPI) or more.

According to an embodiment of the present disclosure, an electronic device includes a processor configured to provide input image data, and a display device including a plurality of pixels, receiving the input image data from the processor and driving the plurality of pixels based on the input image data. Each of the plurality of pixels includes a first transistor including a gate connected to a first node, a first terminal receiving a first power supply voltage and a second terminal connected to a second node, a capacitor including a first electrode connected to a third node and a second electrode connected to the second node, a second transistor disposed between a data line and the third node and transferring a data voltage to the third node in response to a write signal, a third transistor connected to the first node and transferring a reference voltage to the first node in response to the write signal, a fourth transistor disposed between the third node and the first node and connecting the third node to the first node in response to an emission signal, and a light-emitting element including an anode connected to the second node and a cathode which receives a second power supply voltage.

The emission signal may be substantially simultaneously applied to the plurality of pixels. The write signal may be substantially simultaneously applied to the plurality of pixels in an initialization period, and may be sequentially applied to the plurality of pixels on a row-by-row basis in a compensation period.

The first power supply voltage may have a first low voltage level in an initialization period, and may have a first high voltage level in a compensation period, a data writing period and an emission period. The second power supply voltage may have a second high voltage level in the initialization period, the compensation period and the data writing period, and may have a second low voltage level in the emission period.

The reference voltage may be provided through the data line in the initialization period.

The display device may have a resolution of about 1,000 pixels per inch (PPI) or more.

The electronic device may be a virtual reality (VR) device or an augmented reality (AR) device.

A pixel of a display device according to embodiments of the present disclosure may have, for example, a 4T1C structure including first through fourth transistors and a capacitor, and may perform a threshold voltage compensation operation in a source follower manner. Accordingly, the pixel may have a simple configuration, and may be suitable for a display device having a high resolution.

### BRIEF DESCRIPTION OF THE DRAWINGS

Illustrative, non-limiting embodiments will be more clearly understood from the following detailed description in conjunction with the accompanying drawings.

FIG. 1 is a circuit diagram illustrating a pixel according to an embodiment.

FIG. 2 is a timing diagram for describing an operation of a pixel of FIG. 1.

FIG. 3 is a circuit diagram for describing an operation of a pixel of FIG. 1 in an initialization period.

FIG. 4 is a circuit diagram for describing an operation of a pixel of FIG. 1 in a compensation period.

FIG. 5 is a circuit diagram for describing an operation of a pixel of FIG. 1 in a data writing period.

FIG. 6 is a circuit diagram for describing an operation of a pixel of FIG. 1 in an emission period.

FIG. 7 is a circuit diagram illustrating a pixel according to an embodiment.

FIG. 8 is a timing diagram for describing an operation of a pixel of FIG. 7.

FIG. 9 is a circuit diagram illustrating a pixel according to an embodiment.

FIG. 10 is a timing diagram for describing an operation of a pixel of FIG. 9.

FIG. 11 is a circuit diagram illustrating a pixel according to an embodiment.

FIG. 12 is a timing diagram for describing an operation of a pixel of FIG. 11.

FIG. 13 is a block diagram illustrating a display device according to an embodiment.

FIG. 14 is a block diagram illustrating an electronic device including a display device according to an embodiment.

FIG. 15 is a block diagram illustrating an electronic device according to an embodiment.

FIG. 16 is a diagram illustrating examples of wearable electronic devices including a display device according to an embodiment.

### DETAILED DESCRIPTION OF THE INVENTIVE CONCEPT

The embodiments are described more fully hereinafter with reference to the accompanying drawings. Like or similar reference numerals refer to like or similar elements throughout.

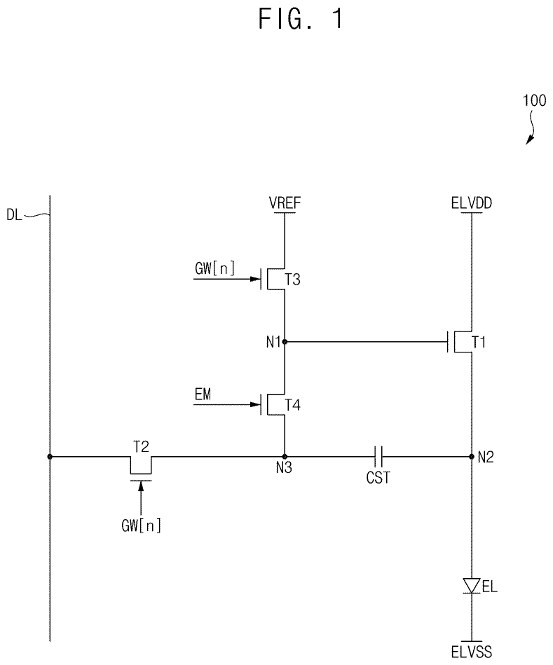

FIG. 1 is a circuit diagram illustrating a pixel according to an embodiment.

Referring to FIG. 1, a pixel 100 according to an embodiment may include a first transistor T1, a second transistor T2, a third transistor T3, a fourth transistor T4, a capacitor CST and a light-emitting element EL.

The first transistor T1 may generate a driving current based on a voltage stored in the capacitor CST. The first transistor T1 may be a driving transistor for driving the light-emitting element EL. The first transistor T1 may include a gate connected to a first node N1, a first terminal (e.g., a drain) which receives a first power supply voltage ELVDD (e.g., a high power supply voltage), and a second terminal (e.g., a source) connected to a second node N2. The first node N1 may be referred to as a gate node, and the second node N2 may be referred to as a source node.

The capacitor CST may be connected between a third node N3 and the second node N2. The capacitor CST may be a storage capacitor for storing a data voltage. The capacitor CST may include a first electrode connected to the third node N3, and a second electrode connected to the second node N2.

The second transistor T2 may connect a data line DL to the third node N3 in response to a write signal GW[n]. The second transistor T2 may be a switching transistor for transferring a voltage from the data line DL. The second transistor T2 may include a gate which receives the write signal GW[n], a first terminal connected to the data line DL, and a second terminal connected to the third node N3.

The third transistor T3 may transfer a reference voltage VREF to the first node N1 in response to the write signal GW[n]. The reference voltage VREF may have a voltage level for turning on the first transistor T1. The third transistor T3 may include a gate which receives the write signal GW[n], a first terminal which receives the reference voltage VREF, and a second terminal connected to the first node N1.

The fourth transistor T4 may connect the third node N3 to the first node N1 in response to an emission signal EM. The fourth transistor T4 may include a gate which receives the emission signal EM, a first terminal connected to the first node N1, and a second terminal connected to the third node N3.

The light-emitting element EL may emit light based on the driving current generated by the first transistor T1. The light-emitting element EL may be, but is not limited to, an organic light emitting diode (“OLED”). The light-emitting element EL may be, but is not limited to, a micro light-emitting diode, a nano light-emitting diode (“NED”), a quantum dot (“QD”) light-emitting diode, an inorganic light-emitting diode, or any other suitable light-emitting element. The light-emitting element EL may include an anode connected to the second node N2, and a cathode which receives a second power supply voltage ELVSS (e.g., a low power supply voltage).

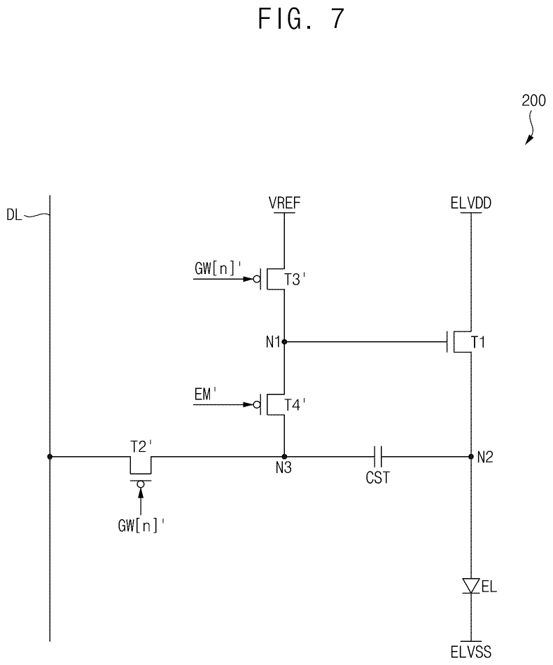

The first transistor T1 (or the driving transistor) may be an N-type metal-oxide-semiconductor (“NMOS”) transistor. Further, the first transistor T1 may be, but is not limited to, an oxide transistor having an active region including an oxide semiconductor. As illustrated in FIG. 1, the second, third and fourth transistors T2, T3 and T4 also may be NMOS transistors. However, the present disclosure is not limited thereto. For example, as described below with reference to FIG. 7, at least one of the second, third and fourth transistors T2, T3 and T4 may be a P-type metal-oxide-semiconductor (“PMOS”) transistor.

As described above, the pixel 100 according to an embodiment may have a simple configuration, or a 4T1C structure including the first through fourth transistors T1 through T4 and the capacitor CST. Accordingly, the pixel 100 may be suitable for a display device having a high resolution. For example, the high resolution may be about 1,000 pixels per inch (“PPI”) or more, and the pixel 100 may be applied to a display device having the high resolution in which each pixel 100 is required to have a small number of transistors.

Hereinafter, an operation of the pixel 100 according to an embodiment is described below with reference to FIGS. 1 through 6.

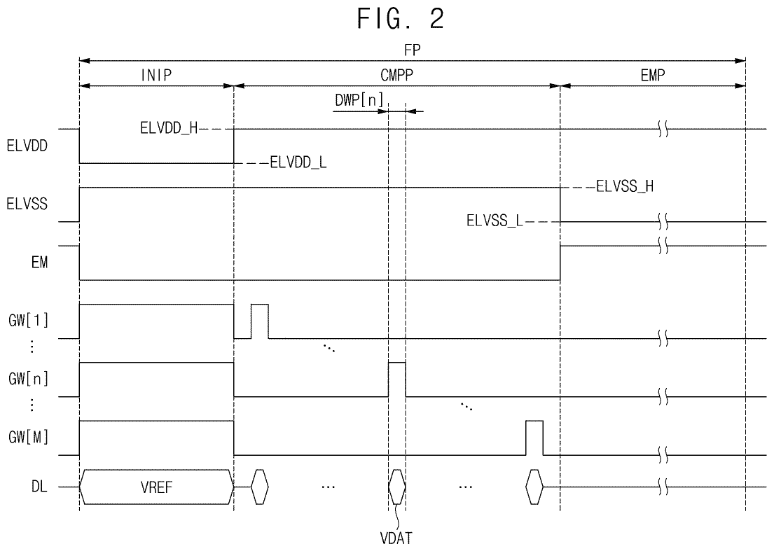

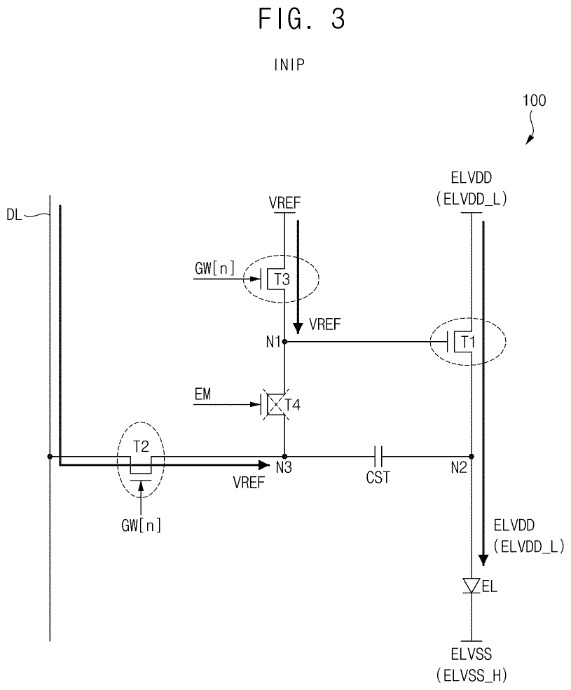

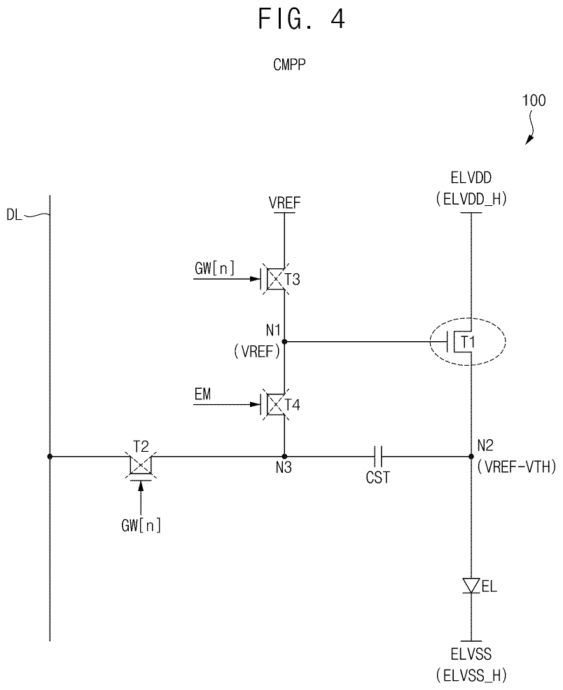

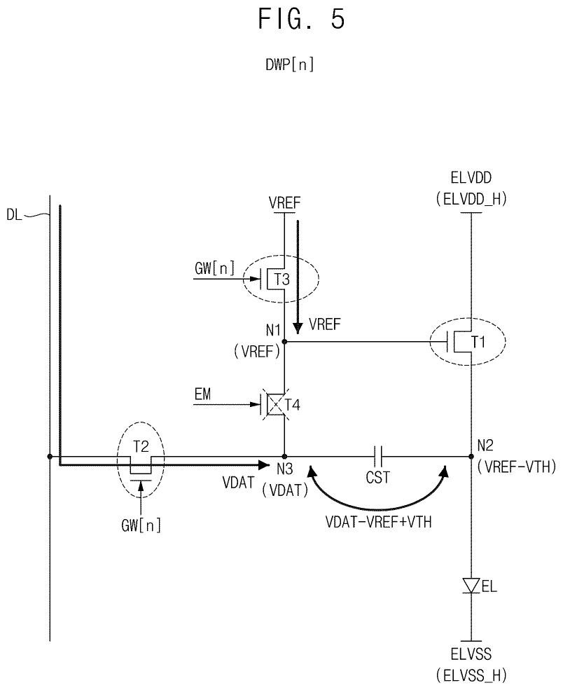

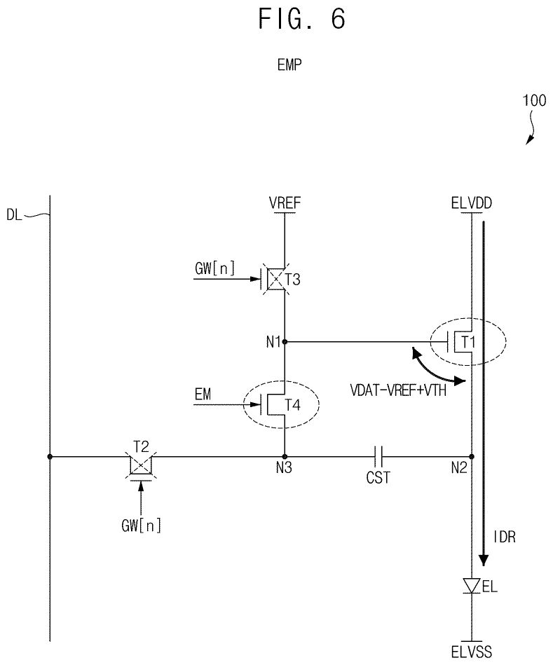

FIG. 2 is a timing diagram for describing an operation of a pixel of FIG. 1, FIG. 3 is a circuit diagram for describing an operation of a pixel of FIG. 1 in an initialization period, FIG. 4 is a circuit diagram for describing an operation of a pixel of FIG. 1 in a compensation period, FIG. 5 is a circuit diagram for describing an operation of a pixel of FIG. 1 in a data writing period, and FIG. 6 is a circuit diagram for describing an operation of a pixel of FIG. 1 in an emission period.

Referring to FIGS. 1 and 2, a frame period FP for the display device including the pixel 100 may include an initialization period INIP in which the first node N1 and the anode of the light-emitting element EL are initialized, a compensation period CMPP in which the threshold voltage of the first transistor T1 is compensated, a data writing period DWP[n] in which the data voltage VDAT for the pixel 100 is provided through the data line DL, and an emission period EMP in which the light-emitting element EL emits light.

The first power supply voltage ELVDD may transition between a first high voltage level ELVDD_H which is a relatively high voltage level and a first low voltage level ELVDD_L which is a relatively low voltage level. For example, as illustrated in FIG. 2, the first power supply voltage ELVDD may have the first low voltage level ELVDD_L in the initialization period INIP, and may have the first high voltage level ELVDD_H in the compensation period CMPP, the data writing period DWP[n] and the emission period EMP. Further, the second power supply voltage ELVSS may transition between a second high voltage level ELVSS_H that is a relatively high voltage level and a second low voltage level ELVSS_L that is a relatively low voltage level. For example, as illustrated in FIG. 2, the second power supply voltage ELVSS may have the second high voltage level ELVSS_H in the initialization period INIP, the compensation period CMPP and the data writing period DWP[n], and may have the second low voltage level ELVSS_L in the emission period EMP. According to an embodiment, the second high voltage level ELVSS_H may be substantially equal to the first high voltage level ELVDD_H, and the second low voltage level ELVSS_L may be substantially equal to the first low voltage level ELVDD_L. However, the present disclosure is not limited thereto. For example, the second high voltage level ELVSS_H may be different from the first high voltage level ELVDD_H, and/or the second low voltage level ELVSS_L may be different from the first low voltage level ELVDD_L.

The emission signal EM may be a global signal that is substantially simultaneously applied to a plurality of pixels of the display device, and the write signals GW[1], . . . . GW[n], . . . , and GW[M] may be signals that are respectively applied to a plurality of scan lines of the display device. As illustrated in FIG. 2, in the initialization period INIP, the emission signal EM having an off-level (e.g., a low level) and the write signals GW[1], . . . . GW[n], . . . , and GW[M] having an on-level (e.g., a high level) may be substantially simultaneously applied to the plurality of pixels. Further, in the compensation period CMPP, the emission signal EM having the off-level may be substantially simultaneously applied to the plurality of pixels, and the write signals GW[1], . . . . GW[n], . . . , and GW[M] having the on-level may be sequentially applied to the plurality of pixels on a row-by-row basis. For example, when the display device includes first through M-th pixel rows (where M is an integer greater than or equal to 2), first through M-th write signals GW[1], . . . . GW[n], . . . , and GW[M] may be sequentially applied to the first through M-th pixel rows in the order from the first write signal GW[1] to the M-th write signal GW[M]. Thus, the compensation period CMPP may include the data writing periods DWP[n] for the first through M-th pixel rows. That is, the data writing period DWP[n] for the pixel 100 may be within the compensation period CMPP. Further, in the emission period EMP, the emission signal EM having the on-level and the write signals GW[1], . . . . GW[n], . . . , and GW[M] having the off-level may be substantially simultaneously applied to the plurality of pixels.

In the initialization period INIP, the first power supply voltage ELVDD may have the first low voltage level ELVDD_L, the second power supply voltage ELVSS may have the second high voltage level ELVSS_H, the write signal GW[n] for the pixel 100 may have the on-level, the emission signal EM may have the off-level, and the reference voltage VREF may be provided through the data line DL. As illustrated in FIG. 3, the fourth transistor T4 may be turned off in response to the emission signal EM having the off-level. The third transistor T3 may be turned on in response to the write signal GW[n] having the on-level, and may transfer the reference voltage VREF to the first node N1. Further, the second transistor T2 may be turned on in response to the write signal GW[n] having the on-level, and may transfer the reference voltage VREF from the data line DL to the third node N3. The first transistor T1 may be turned on in response to the reference voltage VREF at the first node N1, and may transfer the first power supply voltage ELVDD having the first low voltage level ELVDD_L to the anode of the light-emitting element EL. Thus, the first node N1 (or the gate node) may be initialized based on the reference voltage VREF, and the second node N2 and the anode of the light-emitting element EL may be initialized based on the first power supply voltage ELVDD having the first low voltage level ELVDD_L. Further, while the first node N1, the second node N2 and the anode of the light-emitting element EL are initialized, the third node N3 may have the reference voltage VREF.

In the compensation period CMPP (which does not overlap with the data writing period DWP[n] for the pixel 100), the first power supply voltage ELVDD may have the first high voltage level ELVDD_H, the second power supply voltage ELVSS may have the second high voltage level ELVSS_H, the write signal GW[n] for the pixel 100 may have the off-level, and the emission signal EM may have the off-level. As illustrated in FIG. 4, the second and third transistors T2 and T3 may be turned off in response to the write signal GW[n] having the off-level, and the fourth transistor T4 may be turned off in response to the emission signal EM having the off-level. The first transistor T1 may be turned on in response to the reference voltage VREF at the first node N1 until a voltage of the second node N2 becomes a voltage VREF-VTH obtained by subtracting the threshold voltage VTH of the first transistor T1 from the reference voltage VREF. Thus, the voltage of the second node N2 may become the voltage VREF-VTH obtained by subtracting the threshold voltage VTH from the reference voltage VREF. In the compensation period CMPP, since the second power supply voltage ELVSS has the second high voltage level ELVSS_H, the light-emitting element EL may not emit light.

In the data writing period DWP[n] for the pixel 100, the first power supply voltage ELVDD may have the first high voltage level ELVDD_H, the second power supply voltage ELVSS may have the second high voltage level ELVSS_H, the write signal GW[n] for the pixel 100 may have the on-level, the emission signal EM may have the off-level, and the data voltage VDAT for the pixel 100 may be provided through the data line DL. As illustrated in FIG. 5, the fourth transistor T4 may be turned off in response to the emission signal EM having the off-level. The third transistor T3 may be turned on in response to the write signal GW[n] having the on-level, and may transfer the reference voltage VREF to the first node N1. Further, the second transistor T2 may be turned on in response to the write signal GW[n] having the on-level, and may transfer the data voltage VDAT from the data line DL to the third node N3. In addition, the first transistor T1 may be turned on in response to the reference voltage VREF at the first node N1, and may maintain the voltage of the second node N2 as the voltage VREF-VTH, which is obtained by subtracting the threshold voltage VTH from the reference voltage VREF. Thus, the first electrode of the capacitor CST connected to the third node N3 may have the data voltage VDAT, the second electrode of the capacitor CST connected to the second node N2 may have the voltage VREF-VTH, and the capacitor CST may store, between the first electrode and the second electrode of the capacitor CST, a voltage VDAT−VREF+VTH, which is obtained by subtracting the reference voltage VREF from the data voltage VDAT and adding the threshold voltage VTH of the first transistor T1. This operation that stores the voltage VDAT−VREF+VTH, which reflects the threshold voltage VTH of the first transistor T1, between the first electrode and the second electrode of the capacitor CST may be referred to as a threshold voltage compensation operation in a source follower manner.

In the emission period EMP, the first power supply voltage ELVDD may have the first high voltage level ELVDD_H, the second power supply voltage ELVSS may have the second low voltage level ELVSS_L, the write signal GW[n] for the pixel 100 may have the off-level, and the emission signal EM may have the on-level. As illustrated in FIG. 6, the second and third transistors T2 and T3 may be turned off in response to the write signal GW[n] having the off-level. The fourth transistor T4 may be turned on in response to the emission signal EM having the on-level, and may connect the third node N3 to the first node N1. Thus, a gate-source voltage of the first transistor T1 may be the voltage VDAT−VREF+VTH, which is stored between the first electrode and the second electrode of the capacitor CST. The first transistor T1 may generate the driving current IDR based on the voltage VDAT−VREF+VTH stored between the first electrode and the second electrode of the capacitor. The light-emitting element EL may emit light based on the driving current IDR generated by the first transistor T1.

As described above, the pixel 100 of the display device according to an embodiment may have the 4T1C structure including the first through fourth transistors T1 through T4 and the capacitor CST, and may perform the threshold voltage compensation operation in the source follower manner. Accordingly, the pixel 100 may be suitable for a display device having a high resolution. As explained above, the high resolution may be about 1,000 pixels per inch (“PPI”) or more, and the pixel 100 may be applied to a display device having the high resolution in which each pixel 100 is required to have a small number of transistors.

As described above, the display device according to an embodiment may be driven in a simultaneous emission manner in which the emission signal EM is substantially simultaneously applied to the plurality of pixels and the plurality of pixels substantially simultaneously start emitting light in the emission period EMP. In a virtual reality (“VR”) device and/or an augmented reality (“AR”) device, when a plurality of pixels are driven in a progressive emission manner in which the plurality of pixels sequentially start emitting light on a row-by-row basis, a motion blur phenomenon may occur due to a difference in refresh times between a pixel located at the top of a display panel and a pixel located at the bottom of the display panel, and may cause dizziness for a user. However, in a VR device and/or an AR device including the display device according to an embodiment, since the plurality of pixels are driven in the simultaneous emission manner in which the plurality of pixels substantially simultaneously start emitting light, pixels located at the top and bottom of the display panel may be substantially simultaneously refreshed. Thus, in the VR device and/or the AR device including the display device according to an embodiment, the motion blur phenomenon may not occur, and the dizziness for the user may be prevented.

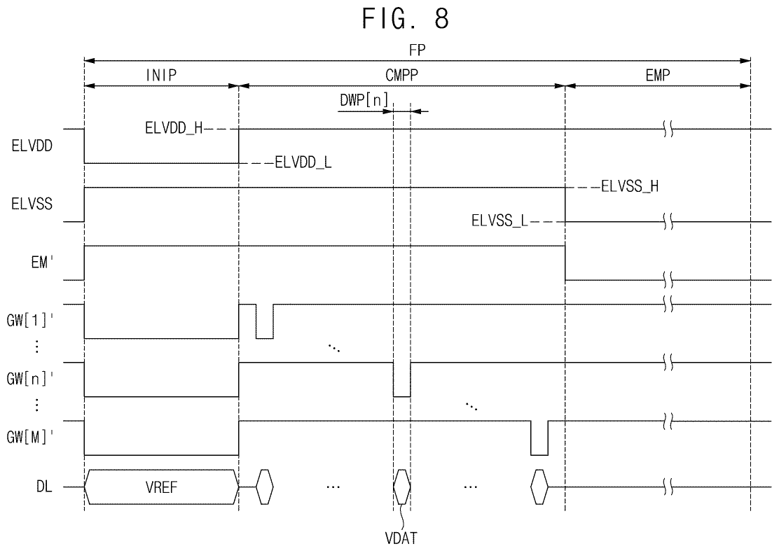

FIG. 7 is a circuit diagram illustrating a pixel according to an embodiment, and FIG. 8 is a timing diagram for describing an operation of a pixel of FIG. 7.

Referring to FIG. 7, a pixel 200 according to an embodiment may include a capacitor CST, a first transistor T1, a second transistor T2′, a third transistor T3′, a fourth transistor T4′ and a light-emitting element EL. The pixel 200 of FIG. 7 may have substantially the same configuration and substantially the same operation as a pixel 100 of FIG. 1, except that at least one of the second transistor T2′, the third transistor T3′ and the fourth transistor T4′ is a PMOS transistor.

As illustrated in FIG. 7, the second transistor T2′, the third transistor T3′ and the fourth transistor T4′ may be PMOS transistors. Further, the write signal GW[n]′ applied to the second and third transistors T2′ and T3′ and the emission signal EM′ applied to the fourth transistor T4′ may be active low signals, having a low level as an on-level and a high level as an off-level. For example, as illustrated in FIG. 8, the emission signal EM′ may have the high level as the off-level in the initialization period INIP and the compensation period CMPP, and may have the low level as the on-level in the emission period EMP. Further, the write signals GW[1]′, . . . . GW[n]′, . . . , and GW[M]′ for first through M-th pixel rows may substantially simultaneously have the low level as the on-level in the initialization period INIP, may sequentially have the low level as the on-level in the compensation period CMPP, and may substantially simultaneously have the high level as the off-level in the emission period EMP. Unlike the pixel 100 illustrated in FIG. 1 and the pixel 200 illustrated in FIG. 7, at least one of the second transistor T2′, the third transistor T3′ and the fourth transistor T4′ may be a PMOS transistor, and remaining transistors among the second transistor T2′, the third transistor T3′ and the fourth transistor T4′ may be an NMOS transistor.

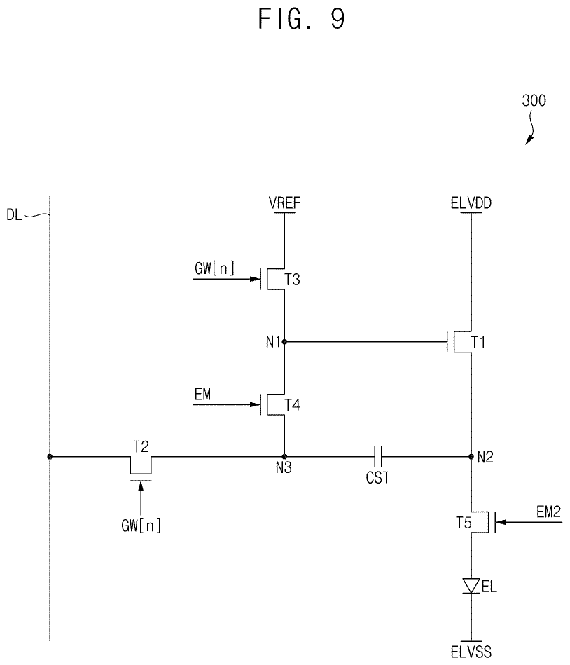

FIG. 9 is a circuit diagram illustrating a pixel according to an embodiment, and FIG. is a timing diagram for describing an operation of a pixel of FIG. 9.

Referring to FIG. 9, a pixel 300 according to an embodiment may include a capacitor CST, a first transistor T1, a second transistor T2, a third transistor T3, a fourth transistor T4, a fifth transistor T5 and a light-emitting element EL. The pixel 300 of FIG. 9 may have substantially the same configuration and substantially the same operation as a pixel 100 of FIG. 1, except that the pixel 300 may further include the fifth transistor T5.

The fifth transistor T5 may be arranged between a second node N2 and an anode of the light-emitting element EL, and may connect the anode of the light-emitting element EL to the second node N2 in response to a second emission signal EM2. The fifth transistor T5 may include a gate which receives the second emission signal EM2, a first terminal connected to the second node N2, and a second terminal connected to the anode of the light-emitting element EL.

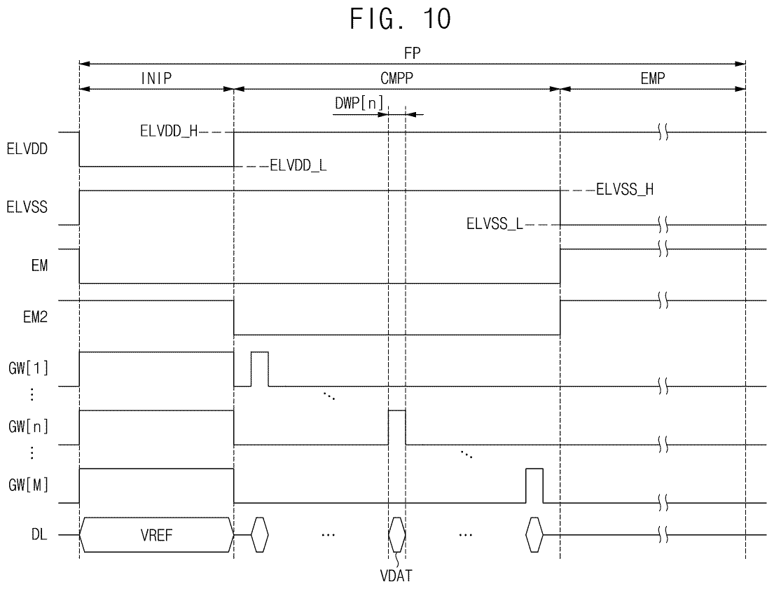

As illustrated in FIG. 10, the second emission signal EM2 may have an on-level in an initialization period INIP and an emission period EMP, and may have an off-level in a compensation period CMPP. Thus, the fifth transistor T5 may connect the anode of the light-emitting element EL to the second node N2 in response to the second emission signal EM2 having the on-level in the initialization period INIP and the emission period EMP, and may disconnect the second node N2 from the anode of the light-emitting element EL in response to the second emission signal EM2 having the off-level in the compensation period CMPP. Thus, while a threshold voltage compensation operation for the pixel 300 is performed, the second node N2 may be disconnected from the anode of the light-emitting element EL, and the threshold voltage compensation operation may be unaffected by a degradation and/or a parasitic capacitor of the light-emitting element EL.

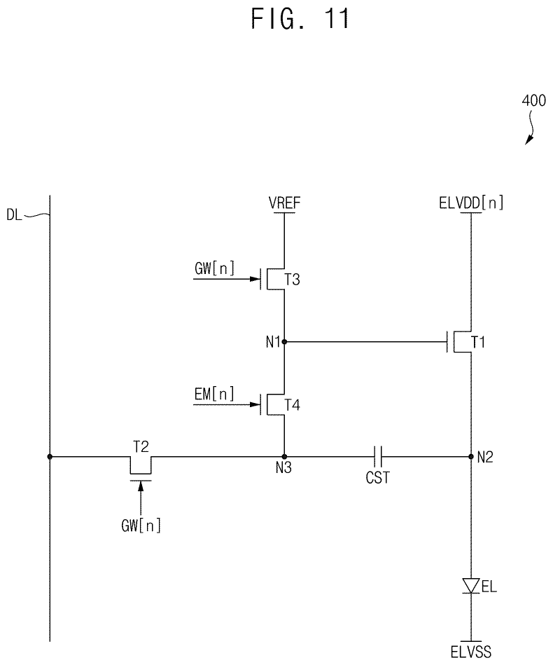

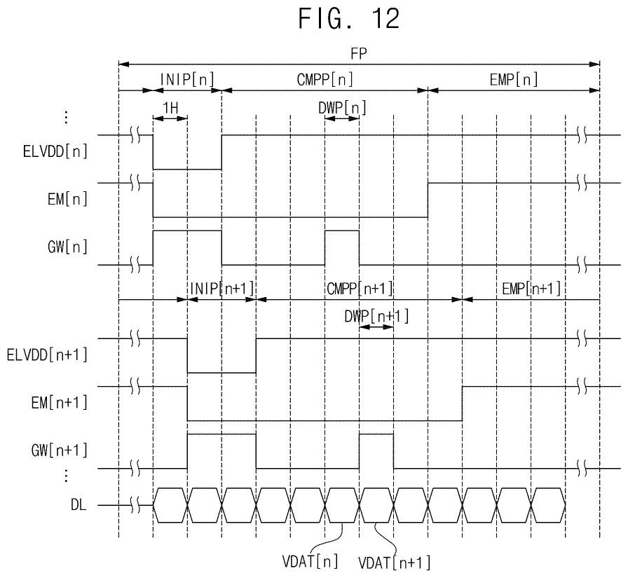

FIG. 11 is a circuit diagram illustrating a pixel according to an embodiment, and FIG. 12 is a timing diagram for describing an operation of a pixel of FIG. 11.

Referring to FIG. 11, a pixel 400 according to an embodiment may include a capacitor CST, a first transistor T1, a second transistor T2, a third transistor T3, a fourth transistor T4 and a light-emitting element EL. The pixel 400 of FIG. 11 may have substantially the same configuration as a pixel 100 of FIG. 1. However, unlike a display device including the pixel 100 of FIG. 1 in which a plurality of pixels substantially simultaneously start emitting light at a start time of an emission period, in a display device including the pixel 400 of FIG. 11, a plurality of pixels may sequentially start emitting light on a row-by-row basis.

In the display device including the pixel 400, not only a write signal GW[n], but also an emission signal EM[n] and a first power supply voltage ELVDD[n] may be sequentially applied to the plurality of pixels on a row-by-row basis.

For example, as illustrated in FIG. 12, a frame period FP for the display device may include an initialization period INIP[n], a compensation period CMPP[n], a data writing period DWP[n] and an emission period EMP[n] for an n-th pixel row (where n is an integer greater than or equal to 1). In an embodiment, the initialization period INIP[n] may have, but is not limited to, a time length corresponding to two horizontal times, the compensation period CMPP[n] may have, but is not limited to, a time length corresponding to six horizontal times, and the data writing period DWP[n] may have, but is not limited to, a time length corresponding to one horizontal time 1H. Here, one horizontal time 1H may be a time allocated to one pixel row, and may correspond to, but is not limited to, a time obtained by dividing the frame period FP by the number of pixel rows of the display device. Further, as illustrated in FIG. 12, the data writing period DWP[n] may be within the compensation period CMPP[n].

In the initialization period INIP[n] for the n-th pixel row, a first power supply voltage ELVDD[n] for the n-th pixel row may have a first low voltage level ELVDD_L, the emission signal EM[n] for the n-th pixel row may have an off-level, and the write signal GW[n] for the n-th pixel row may have an on-level. In the compensation period CMPP[n] for the n-th pixel row (which does not overlap with the data writing period DWP[n] for the n-th pixel row), the first power supply voltage ELVDD[n] for the n-th pixel row may have a first high voltage level ELVDD_H, the emission signal EM[n] for the n-th pixel row may have the off-level, and the write signal GW[n] for the n-th pixel row may have the off-level. In the data writing period DWP[n] for the n-th pixel row, the write signal GW[n] for the n-th pixel row may be changed from the off-level to the on-level, and n-th data voltages VDAT[n] may be written or stored in the pixels of the n-th pixel row. In the emission period EMP[n] for the n-th pixel row, the first power supply voltage ELVDD[n] may have the first high voltage level ELVDD_H, the emission signal EM[n] for the n-th pixel row may have the on-level, and the write signal GW[n] for the n-th pixel row may have the off-level. Further, in the emission period EMP[n] for the n-th pixel row, the pixels of the n-th pixel row may emit light based on the n-th data voltages VDAT[n].

Further, as illustrated in FIG. 12, an initialization period INIP[n+1], a compensation period CMPP[n+1], a data writing period DWP[n+1] and an emission period EMP[n+1] for an (n+1)-th pixel row may be shifted or delayed by one horizontal time 1H from the initialization period INIP[n], the compensation period CMPP[n], the data writing period DWP[n] and the emission period EMP[n] for the n-th pixel row, respectively. In addition, as illustrated in FIG. 12, the first power supply voltage ELVDD[n+1], the emission signal EM[n+1] and the write signal GW[n+1] for the (n+1)-th pixel row may be shifted or delayed by one horizontal time 1H from the first power supply voltage ELVDD[n], the emission signal EM[n] and the write signal GW[n] for the n-th pixel row, respectively. In the emission period EMP[n+1] for the (n+1)-th pixel row, the pixels of the (n+1)-th pixel row may emit light based on (n+1)-th data voltages VDAT[n+1].

In this manner, the plurality of pixels of the display device including the pixel 400 may sequentially emit light on a row-by-row basis.

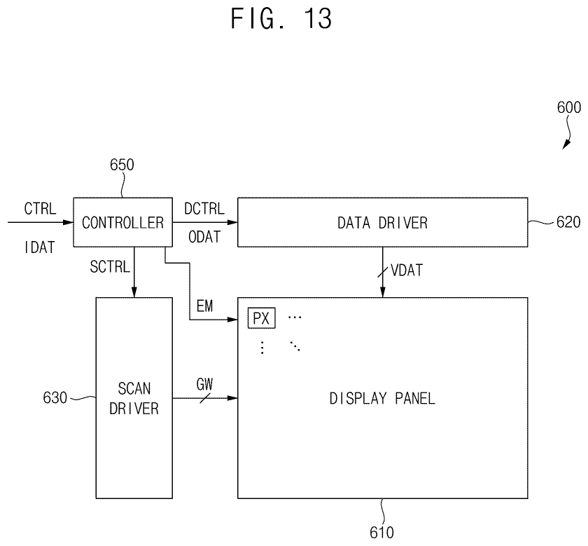

FIG. 13 is a block diagram illustrating a display device according to an embodiment.

Referring to FIG. 13, a display device 600 according to an embodiment may include a display panel 610, a data driver 620, a scan driver 630 and a controller 650.

The display panel 610 may include a plurality of pixels PX. According to embodiments, each pixel PX of the display panel 610 may be a pixel 100 of FIG. 1, a pixel 200 of FIG. 7, a pixel 300 of FIG. 9, a pixel 400 of FIG. 11, or a pixel having a similar structure. For example, each pixel PX may have a simple configuration of a 4T1C structure or a 5T1C structure, and may be suitable for a high-resolution display device. The high-resolution display device according to an embodiment may refer to a display device 600 having a resolution of about 1,000 PPI or more.

The data driver 620 may provide data voltages VDAT to the plurality of pixels PX based on a data control signal DCTRL and output image data ODAT received from the controller 650. The data control signal DCTRL may include, but is not limited to, an output data enable signal, a horizontal start signal and a load signal. The data driver 620 and the controller 650 may be implemented as a single integrated circuit, and the single integrated circuit may be referred to as a timing controller embedded data driver (“TED”) integrated circuit. However, the present disclosure is not limited thereto. For example, the data driver 620 and the controller 650 may be implemented as separate integrated circuits.

The scan driver 630 may provide write signals GW to the plurality of pixels PX based on a scan control signal SCTRL received from the controller 650. The scan control signal SCTRL may include, but is not limited to, a scan start signal and a scan clock signal. According to embodiments, as illustrated in FIGS. 2, 8, and 10, the scan driver 630 may substantially simultaneously apply the write signals GW having an on-level to the plurality of pixels PX of the display panel 610 in an initialization period INIP, and may sequentially apply the write signals GW having the on-level to the plurality of pixels PX on a row-by-row basis in a compensation period CMPP. However, the present disclosure is not limited thereto. For example, as illustrated in FIG. 12, the scan driver 630 may sequentially apply the write signals GW having the on-level to the plurality of pixels PX on a row-by-row basis in a frame period FP. The scan driver 630 may be integrated or formed in the display panel 610. The scan driver 630 may be implemented with one or more integrated circuits.

The controller 650 (e.g., a timing controller) may receive input image data IDAT and a control signal CTRL from an external processor (e.g., a graphics processing unit (“GPU”), an application processor (“AP”) or a graphics card). The control signal CTRL may include, but is not limited to, a vertical synchronization signal, a horizontal synchronization signal, an input data enable signal, a master clock signal, etc. The controller 650 may generate the output image data ODAT, the data control signal DCTRL and the scan control signal SCTRL based on the input image data IDAT and the control signal CTRL. The controller 650 may control the data driver 620 by providing the output image data ODAT and the data control signal DCTRL to the data driver 620, and may control the scan driver 630 by providing the scan control signal SCTRL to the scan driver 630.

The controller 650 may substantially simultaneously provide an emission signal EM to the plurality of pixels PX of the display panel 610. In a virtual reality (“VR”) device and/or an augmented reality (“AR”) device including the display device 600, the plurality of pixels PX may be driven in a simultaneous emission manner in which the plurality of pixels PX substantially simultaneously start emitting light, thereby preventing a motion blur phenomenon and dizziness for a user. Further, in this case, the display device 600 may not include a separate emission driver for providing the emission signal EM to the plurality of pixels PX, and may have a narrow bezel. However, the present disclosure is not limited thereto. For example, the emission signal EM provided to the plurality of pixels PX of the display panel 610 at a substantially simultaneous time may be received from the external processor. For example, as illustrated in FIG. 12, the display device 600 may include an emitting driver that sequentially provides the emission signals EM to the plurality of pixels PX on a row-by-row basis. In this case, the emission driver may be integrated or formed in the display panel 610, or may be implemented with one or more integrated circuits.

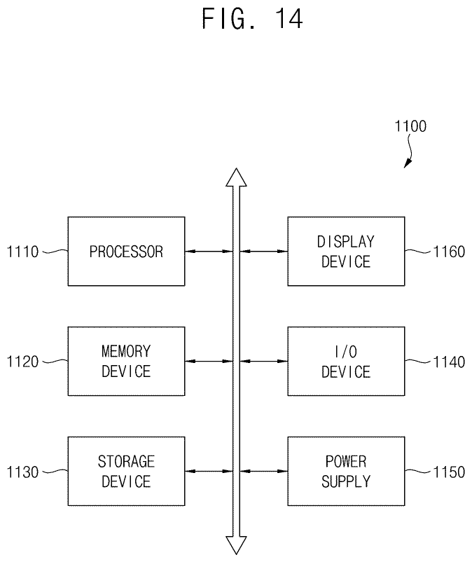

FIG. 14 is a block diagram illustrating an electronic device including a display device according to an embodiment.

Referring to FIG. 14, an electronic device 1100 may include a processor 1110, a memory device 1120, a storage device 1130, an input/output (I/O) device 1140, a power supply 1150 and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, the processor 1110 may be further coupled to an extended bus such as a peripheral component interconnection (“PCI”) bus. The processor 1110 may output the input image data IDAT and the control signal CTRL to the controller 650 of FIG. 13.

The memory device 1120 may store data for operations of the electronic device 1100. For example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, each pixel may have, for example, a 4T1C structure including first through fourth transistors and a capacitor, and may perform a threshold voltage compensation operation in a source follower manner. Accordingly, the pixel may have a simple configuration, and may be suitable for the display device 1160 having a high resolution.

The inventive concepts of the present disclosure may be applied to any electronic device 1100 including the display device 1160. For example, the inventive concepts may be applied to a virtual reality (“VR”) device, an augmented reality (“AR”) device, a mixed reality (“MR”) device, an extended reality (“XR”) device, a mobile phone, a smart phone, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

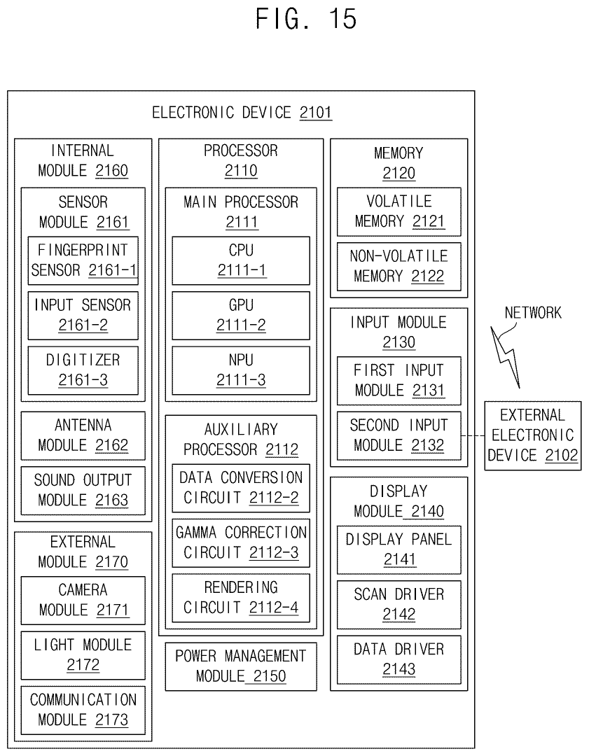

FIG. 15 is a block diagram illustrating an example of an electronic device according to an embodiment.

An electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

In an embodiment, when personal information authentication is executed in the display module 2140, a fingerprint sensor 2161-1 may obtain fingerprint information of the user as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

In an embodiment, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 15, the electronic device 2101 may communicate with an external electronic device 2102 via a network (e.g., a short-range wireless communication network or a long-range wireless communication network). According to an embodiment, the electronic device 2101 may include the processor 2110, the memory 2120, the input module 2130, the display module 2140, a power management module 2150, an internal module 2160 and an external module 2170. According to an embodiment, at least one of the components may be omitted from the electronic device 2101, or one or more other components may be added in the electronic device 2101. According to an embodiment, some of the above-described components (e.g., the sensor module 2161, an antenna module 2162, or the sound output module 2163) may be implemented into another component (e.g., the display module 2140).

The processor 2110 may execute software to control at least one other component (e.g., a hardware or software component) of the electronic device 2101 coupled with the processor 2110, and may perform various data processing or computation. According to an embodiment, as at least part of the data processing or computation, the processor 2110 may store a command or data received from another component (e.g., the input module 2130, the sensor module 2161 or a communication module 2173) in a volatile memory 2121, may process the command or the data stored in the volatile memory 2121, and may store the result of the processing or computation in a non-volatile memory 2122.

The processor 2110 may include a main processor 2111 and an auxiliary processor 2112. The main processor 2111 may include one or more of a central processing unit (“CPU”) 2111-1 or an application processor (“AP”). The main processor 2111 may further include any one or more of a graphics processing unit (“GPU”) 2111-2, a communication processor (“CP”), and an image signal processor (“ISP”). The main processor 2111 may further include a neural processing unit (“NPU”) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (“DNN”), a convolutional neural network (“CNN”), a recurrent neural network (“RNN”), a restricted Boltzmann machine (“RBM”), a deep belief network (“DBN”), a bidirectional recurrent deep neural network (“BRDNN”), deep Q-network or a combination of two or more of the above. However, the artificial neural network of the present disclosure is not limited to the above examples. The artificial intelligence model may, additionally or alternatively, include a software structure other than a hardware structure. At least two of the above-described processing units and processors may be implemented as an integrated component (e.g., a single chip), or each of the processing units and the processors may be implemented as independent components (e.g., a plurality of chips).

The auxiliary processor 2112 may include a controller. The controller included in the auxiliary processor 2112 may correspond to a controller 650 illustrated in FIG. 13. The controller may include an interface conversion circuit and a timing control circuit. The controller may receive an image signal from the main processor 2111, may convert a data format of the image signal to meet interface specifications with the display module 2140, and may output image data. The controller may output various control signals for driving the display module 2140.

The auxiliary processor 2112 may further include a data conversion circuit 2112-2, a gamma correction circuit 2112-3, a rendering circuit 2112-4, or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage such that an image displayed on the electronic device 2101 has desired gamma characteristics. The rendering circuit 2112-4 may receive image data from the controller, and may render the image data in consideration of a pixel arrangement of the display panel 2141 in the electronic device 2101. At least one of the data conversion circuit 2112-2, the gamma correction circuit 2112-3 and the rendering circuit 2112-4 may be integrated into another component (e.g., the main processor 2111 or the controller). At least one of the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data related to corresponding command. The memory 2120 may include at least one of the volatile memory 2121 and the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. According to an embodiment, the second input module 2132 may include a high definition multimedia interface (“HDMI”), a universal serial bus (“USB”) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a plurality of pixels. Each pixel may have, for example, a 4T1C structure including first through fourth transistors and a capacitor, and may perform a threshold voltage compensation operation in a source follower manner. Accordingly, the pixel may have a simple configuration, and may be suitable for a high-resolution display device.

The display panel 2141 may include a liquid crystal display panel, an organic light emitting display panel or an inorganic light emitting display panel, but the type of the display panel 2141 is not limited thereto. The display panel 2141 may be a rigid type display panel, or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. However, the present disclosure is not limited thereto. For example, the scan driver 2142 may be integrated into the display panel 2141. For example, the scan driver 2142 may include an amorphous silicon TFT gate driver circuit (“ASG”), a low temperature polycrystalline silicon (“LTPS”) TFT gate driver circuit or an oxide semiconductor TFT gate driver circuit (“OSG”) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include a voltage generator circuit. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable, or a fuel cell. The power management module 2150 may include a power management integrated circuit (“PMIC”). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131, and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the input by the user's body or the input by the pen. The input sensor 2161-2 may convert a capacitance change caused by the input into the data value. The input sensor 2161-2 may detect the input by the passive pen, or may transmit/receive data to/from the active pen.

The input sensor 2161-2 may measure a bio-signal, such as blood pressure, moisture or body fat. For example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141, or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. According to an embodiment, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-3 may be simultaneously formed with the display panel 2141 through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (“IR”) sensor, a biometric sensor, a temperature sensor, a humidity sensor or an illuminance sensor.

The antenna module 2162 may include one or more antennas for transmitting or receiving a signal or power to or from the outside. According to an embodiment, the communication module 2173 may transmit a signal to the external electronic device 2102 or receive a signal from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker. A sound output pattern of the sound output module 2163 may be integrated into the display module 2140.

The camera module 2171 may capture a still image and a moving image. According to an embodiment, the camera module 2171 may include one or more lenses, an image sensor or an image signal processor. The camera module 2171 may further include an infrared camera capable of determining the presence or absence of the user, the user's location and the user's line of sight.

The light module 2172 may provide light. The light module 2172 may include a light emitting diode or a xenon lamp. The light module 2172 may operate in conjunction with the camera module 2171, or may operate independently from the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (“GNSS”) communication module) or a wired communication module (e.g., a local area network (“LAN”) communication module or a power line communication (“PLC”) module). The communication module 2173 may communicate with the external electronic device 2102 via a short-range communication network (e.g., Bluetooth™, wireless-fidelity (“Wi-Fi”) direct, or infrared data association (“IrDA”)) or a long-range communication network (e.g., a cellular network, the Internet or a computer network (e.g., LAN or wide area network (“WAN”))). These various types of communication modules 2173 may be implemented as a single chip, or may be implemented as multi-chips separate from each other. The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, the processor 2110 may generate image data corresponding to input data applied through a mouse or an active pen, and may output the image data to the display module 2140. In addition, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the input data sensed by the input sensor 2161-2 or the digitizer 2161-3. When the sensor module 2161 includes a temperature sensor, the processor 2110 may receive temperature data from the sensor module 2161, and may further perform luminance correction on the image data based on the temperature data.

The processor 2110 may receive the determined data about the presence or absence of the user, the location of the user and the user's line of sight from the camera module 2171. The processor 2110 may further perform luminance correction on the image data based on the determined data. For example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (“GPIO”), serial peripheral interface (“SPI”), mobile industry processor interface (“MIPI”) or ultra-path interconnect (“UPI”)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

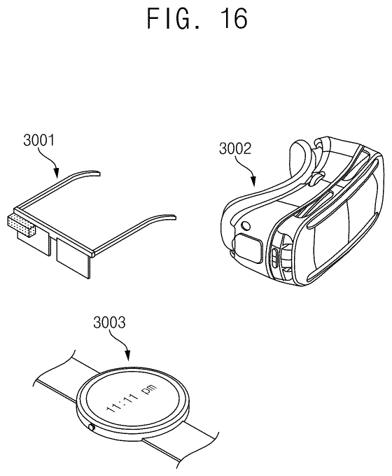

FIG. 16 is a diagram illustrating examples of wearable electronic devices including a display device according to an embodiment.

Referring to FIG. 16, a wearable electronic device including a display device according to an embodiment may be smart glasses 3001, a head-mounted display 3002, a smart watch 3003, etc.

The smart glasses 3001 and the head-mounted display 3002 may include a display module that emits a display image, and a reflector that reflects the emitted display image to provide the reflected display image to eyes of a user, thereby providing a screen in virtual reality or augmented reality to the user. In other words, the display device according to an embodiment may be included in a virtual reality (VR) device and/or an augmented reality (AR) device. Further, in the VR device and/or the AR device, a plurality of pixels may be driven in a simultaneous emission manner in which the plurality of pixels substantially simultaneously start emitting light, thereby preventing a motion blur phenomenon and dizziness for the user.

The smart watch 3003 may include a biometric sensor as an input device, and may provide biometric information recognized by the biometric sensor to the user through a display module.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A pixel of a display device comprising:
a first transistor including a gate connected to a first node, a first terminal receiving a first power supply voltage, and a second terminal connected to a second node;
a capacitor including a first electrode connected to a third node, and a second electrode connected to the second node;
a second transistor including a gate receiving a write signal, a first terminal connected to a data line, and a second terminal connected to the third node;
a third transistor including a gate receiving the write signal, a first terminal receiving a reference voltage, and a second terminal connected to the first node;
a fourth transistor including a gate receiving an emission signal, a first terminal connected to the first node, and a second terminal connected to the third node; and
a light-emitting element including an anode connected to the second node, and a cathode receiving a second power supply voltage.

2. The pixel of claim 1, wherein the display device includes a plurality of pixels,
wherein the emission signal is substantially simultaneously applied to the plurality of pixels, and
wherein the write signal is substantially simultaneously applied to the plurality of pixels in an initialization period, and is sequentially applied to the plurality of pixels on a row-by-row basis in a compensation period.

3. The pixel of claim 1, wherein the first power supply voltage has a first low voltage level in an initialization period, and has a first high voltage level in a compensation period, a data writing period and an emission period, and
wherein the second power supply voltage has a second high voltage level in the initialization period, the compensation period and the data writing period, and has a second low voltage level in the emission period.

4. The pixel of claim 1, wherein the reference voltage is provided through the data line in an initialization period.

5. The pixel of claim 1, wherein a frame period for the display device includes:
an initialization period in which the first node and the anode of the light-emitting element are initialized;
a compensation period in which a threshold voltage of the first transistor is compensated;
a data writing period in which a data voltage is provided through the data line; and
an emission period in which the light-emitting element emits light.

6. The pixel of claim 5, wherein, in the initialization period,
the first power supply voltage has a first low voltage level, the second power supply voltage has a second high voltage level, the write signal has an on-level, the emission signal has an off-level, and the reference voltage is provided through the data line,
the third transistor is turned on in response to the write signal having the on-level, and transfers the reference voltage to the first node,
the second transistor is turned on in response to the write signal having the on-level, and transfers the reference voltage from the data line to the third node,
the first transistor is turned on in response to the reference voltage at the first node, and transfers the first power supply voltage having the first low voltage level to the anode of the light-emitting element,
the first node is initialized based on the reference voltage, and
the anode of the light-emitting element is initialized based on the first power supply voltage having the first low voltage level.

7. The pixel of claim 5, wherein, in the compensation period,
the first power supply voltage has a first high voltage level, the second power supply voltage has a second high voltage level, and the emission signal has an off-level, and
the first transistor is turned on until a voltage of the second node becomes a voltage obtained by subtracting the threshold voltage of the first transistor from the reference voltage.

8. The pixel of claim 5, wherein, in the data writing period,
the first power supply voltage has a first high voltage level, the second power supply voltage has a second high voltage level, the write signal has an on-level, the emission signal has an off-level, and the data voltage is provided through the data line,
the third transistor is turned on in response to the write signal having the on-level, and transfers the reference voltage to the first node,
the second transistor is turned on in response to the write signal having the on-level, and transfers the data voltage from the data line to the third node,
the first transistor is turned on in response to the reference voltage at the first node, and
the capacitor stores, between the first electrode and the second electrode, a voltage obtained by subtracting the reference voltage from the data voltage and adding the threshold voltage of the first transistor.

9. The pixel of claim 5, wherein the data writing period is within the compensation period.

10. The pixel of claim 5, wherein, in the emission period,
the first power supply voltage has a first high voltage level, the second power supply voltage has a second low voltage level, the write signal has an off-level, and the emission signal has an on-level,
the fourth transistor is turned on in response to the emission signal having the on-level, and connects the third node to the first node,
the first transistor generates a driving current based on a voltage stored in the capacitor, and
the light-emitting element emits light based on the driving current.

11. The pixel of claim 1, wherein the display device includes a plurality of pixels,
wherein the emission signal is sequentially applied to the plurality of pixels on a row-by-row basis, and
wherein the write signal is sequentially applied to the plurality of pixels on a row-by-row basis.

12. The pixel of claim 1, wherein the first transistor is an N-type metal-oxide-semiconductor transistor.

13. The pixel of claim 1, further comprising:
a fifth transistor located between the second node and the anode of the light-emitting element, and configured to connect the anode of the light-emitting element to the second node in response to another emission signal.

14. A display device comprising:
a display panel including a plurality of pixels;
a data driver configured to provide a data voltage to each of the plurality of pixels;
a scan driver configured to provide a write signal to each of the plurality of pixels; and
a controller configured to control the data driver and the scan driver,
wherein each of the plurality of pixels includes:
a first transistor including a gate connected to a first node, a first terminal receiving a first power supply voltage, and a second terminal connected to a second node;
a capacitor including a first electrode connected to a third node, and a second electrode connected to the second node;
a second transistor disposed between a data line and the third node, and transferring the data voltage to the third node in response to the write signal;
a third transistor connected to the first node, and transferring a reference voltage to the first node in response to the write signal;
a fourth transistor disposed between the third node and the first node, and connecting the third node to the first node in response to an emission signal; and
a light-emitting element including an anode connected to the second node, and a cathode receiving a second power supply voltage.

15. The display device of claim 14, wherein the scan driver substantially simultaneously applies the write signal to the plurality of pixels in an initialization period, and sequentially applies the write signal to the plurality of pixels on a row-by-row basis in a compensation period, and
wherein the controller simultaneously applies the emission signal to the plurality of pixels.

16. The display device of claim 14, wherein the display device has a resolution of about 1,000 pixels per inch (PPI) or more.

17. An electronic device comprising:
a processor configured to provide input image data; and
a display device including a plurality of pixels, receiving the input image data from the processor, and driving the plurality of pixels based on the input image data,
wherein each of the plurality of pixels includes:
a first transistor including a gate connected to a first node, a first terminal receiving a first power supply voltage, and a second terminal connected to a second node;
a capacitor including a first electrode connected to a third node, and a second electrode connected to the second node;
a second transistor disposed between a data line and the third node, and transferring a data voltage to the third node in response to a write signal;
a third transistor connected to the first node, and transferring a reference voltage to the first node in response to the write signal;
a fourth transistor disposed between the third node and the first node, and connecting the third node to the first node in response to an emission signal; and
a light-emitting element including an anode connected to the second node, and a cathode receiving a second power supply voltage.

18. The electronic device of claim 17, wherein the emission signal is substantially simultaneously applied to the plurality of pixels, and
wherein the write signal is substantially simultaneously applied to the plurality of pixels in an initialization period, and is sequentially applied to the plurality of pixels on a row-by-row basis in a compensation period.

19. The electronic device of claim 17, wherein the first power supply voltage has a first low voltage level in an initialization period, and has a first high voltage level in a compensation period, a data writing period and an emission period, and
wherein the second power supply voltage has a second high voltage level in the initialization period, the compensation period and the data writing period, and has a second low voltage level in the emission period.

20. The electronic device of claim 17, wherein the electronic device is a virtual reality (VR) device or an augmented reality (AR) device.
